(19) United States
(12) Patent Application Publication
(10) Pub. No.: US 2016/0301603 A1
(43) Pub. Date: Oct. 13, 2016

(54) INTEGRATED ROUTING METHOD BASED ON SOFTWARE-DEFINED NETWORK AND SYSTEM THEREOF

(71) Applicant: KULCLOUD, Seongnam-si (KR)

(72) Inventors: Suengyoung PARK, Yongin-si (KR); Seokhwan KONG, Yongin-si (KR); Dipjyoti SAIKIA, Seongnam-si (KR); Nikhil MALIK, Seang nam-si (KR)

(73) Assignee: KULCLOUD, Seongnam-si (KR)

(21) Appl. No.: 14/933,579

(22) Filed: Nov. 5, 2015

(30) Foreign Application Priority Data
Apr. 10, 2015 (KR) 10-2015-0050579

(51) Int. Cl. H04L 12/713; H04L 12/935; H04L 12/721; H04L 12/24

(52) U.S. Cl. CPC H04L 45/586; H04L 41/0893; H04L 49/3063; H04L 45/38

(57) ABSTRACT

An integrated routing method in an integrated routing system based on a software-defined network (SDN), including: obtaining information regarding a plurality of edge switches that are SDN-based switches and belong to a switch group that establishes an independent network; and setting the independent network as at least one virtual router, based on the obtained information regarding the plurality of edge switches, such that the independent network is treated as at least one legacy router by a plurality of legacy networks that are connected to the independent network.

### CROSS-REFERENCE TO RELATED APPLICATION(S)

This application claims priority to Korean Patent Application No. 10-2015-0050579, filed on Apr. 10, 2015, in the Korean Intellectual Property Office, the disclosure of which is incorporated herein by reference in its entirety.

### BACKGROUND

The following description relates to an integrated routing method based on a software-defined network (SDN) and a system thereof, and more particularly, to an integrated routing method and system thereof which enables packet flow between an existing legacy network and an SDN.

With an explosive growth of mobile devices and server virtualization and the advent of cloud service, network demand has increased. Software-defined networking (SDN) is an approach to computer networking that allows network administrators to manage network services through abstraction of lower-level functionality. This is done by decoupling the system that makes decisions about where traffic is sent (the control plane) from the underlying systems that forward traffic to the selected destination (the data plane).

OpenFlow is one such mechanism which separates high-speed data-plane and high-level routing decision functions. Packet forwarding plane is related to a switch end, whereas a high-level routing decision is involved with a separate controller, and the switch end and the controller communicate with each other through OpenFlow protocol.

However, given that a transition from existing networks to SDN is in progress, there is a need to define an interface which bridges the existing legacy protocols and devices seamlessly with SDN. For such hybrid SDN, equipment or devices that constitute the SDN may need to consume less computing resources or networking resources and have a simple structure and management

### RELATED ART DOCUMENTS

### Non-Patent Documents

1. OpenFlow Switch Specification version 1.4.0(Wire Protocol 0x05), Oct. 14, 2013 [https://www.opennetworking.org/images/stories/downloads/sdn-resources/onf-specifications/openflow/openflow-spec-v1.4.0.pdf]

2. Software-Defined Networking: The New Norm for Networks, ONF White Paper, Apr. 13, 2012 [https://www.opennetworking org/images/stories/downloads/sdn-resources/white-papers/wp-sdn-newnorm.pdf]

3. ETSI GS NFV 002 v1.1.1 (2013 October)

[http://www.etsi.org/deliver/etsi_gs/NFV/001_099/002/01.01.01_60/gs_NFV002v010101 p.pdf]

### SUMMARY

The following description relates to an integrated routing method which allows the support of a legacy network in a software-defined network (SDN) and allows information of SDN domain to be distributed to legacy network domain.

In one general aspect, an integrated routing method based on a software-defined network (SDN) is provided, including: obtaining information regarding a plurality of edge switches that are SDN-based switches and belong to a switch group that establishes an independent network; and setting the independent network as at least one virtual router, based on the obtained information regarding the plurality of edge switches, such that the independent network is treated as at least one legacy router by a plurality of legacy networks that are connected to the independent network.

In another general aspect, an integrated routing system based on an SDN is provided, including: a controller configured to obtain information regarding a plurality of OpenFlow edge switches that are connected to a plurality of legacy networks and belong to a switch group; and a legacy routing container configured to generate at least one virtual router based on the obtained information regarding the plurality of OpenFlow edge switches, such that the plurality of legacy networks to treat at least part of the switch group as a legacy router, and to generate legacy routing information in response to a flow processing query message from the controller based on information about the at least one virtual router.

In yet another general aspect, a legacy routing container is provided including: an SDN interface module configured to communicate with a controller that obtains information regarding a plurality of OpenFlow edge switches that are connected to a plurality of legacy networks and belong to a switch group; a virtual router generator configured to generate at least a part of the switch group, which has been received through the SDN interface module, as at least one virtual router; and a routing processor configured to, in response to generation of the at least one virtual router, generate a routing table to be referenced for legacy routing and to generate a legacy routing route for a flow queried by the controller.

Other features and aspects will be apparent from the following detailed description, the drawings, and the claims.

### BRIEF DESCRIPTION OF THE DRAWINGS

FIG. 1 is a block diagram illustrating a software-defined network (SDN) system according to an exemplary embodiment of the present invention.

FIG. 2 is a block diagram illustrating a controller of the SDN system of FIG. 1.

FIG. 3 is a block diagram illustrating a switch of the SDN system of FIG. 1.

FIG. 4 illustrates a field table of a flow entry and an operation table showing types of operations according to the flow entry.

FIG. 5 illustrates field tables of a group table and a meter table.

FIG. 6 is a block diagram illustrating a network system that includes an integrated routing system according to an exemplary embodiment of the present invention.

FIG. 7 is a block diagram illustrating the network system of FIG. 6 being virtualized.

FIG. 8 is a block diagram illustrating an SDN controller according to another exemplary embodiment of the present invention.

FIG. 9 is a block diagram illustrating a legacy routing container according to an exemplary embodiment of the present invention.

FIG. 10 is a flowchart of a method of the controller of FIG. 6 to determine whether to perform legacy routing for a flow.

FIG. 11 is a signal flow chart according to an integrated routing method according to an exemplary embodiment of the present invention.

FIG. 12 is a signal flow chart illustrating an integrated routing method according to another exemplary embodiment of the present invention.

FIG. 13 is a flow table according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

It will be understood that, although the terms first, second, etc. may be used herein to describe various elements, these elements should not be limited by these terms. These terms are only used to distinguish one element from another. For example, a first portion could be termed a second portion, and, similarly, a second portion could be termed a first portion without departing from the teachings of the disclosure. As used herein, the term “and/or” includes any and all combinations of one or more of the associated listed items. As used herein, the singular forms “a,” “an,” and “the” are intended to include the plural forms as well as the singular forms, unless the context clearly indicates otherwise.

When an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present. In addition, it is understood that when a first element is connected to or accesses a second element in a network, the first element and the second element can transmit and receive data therebetween.

In the following description, usage of suffixes such as ‘module’ or ‘unit’ used for referring to elements is given merely to facilitate explanation of the present invention, without having any significant meaning by itself Thus, the ‘module’ and ‘unit’ may be used together.

When the elements described herein are implemented in the actual applications, two or more elements may be combined into a single element, or one element may be subdivided into two or more elements, as needed. Throughout the drawings and the detailed description, unless otherwise described, the same drawing reference numerals are understood to refer to the same elements, features, and structures.

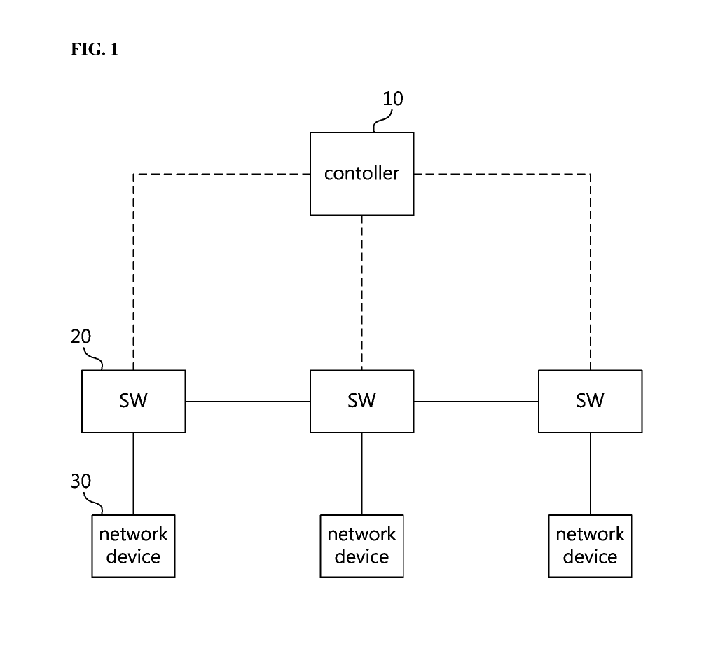

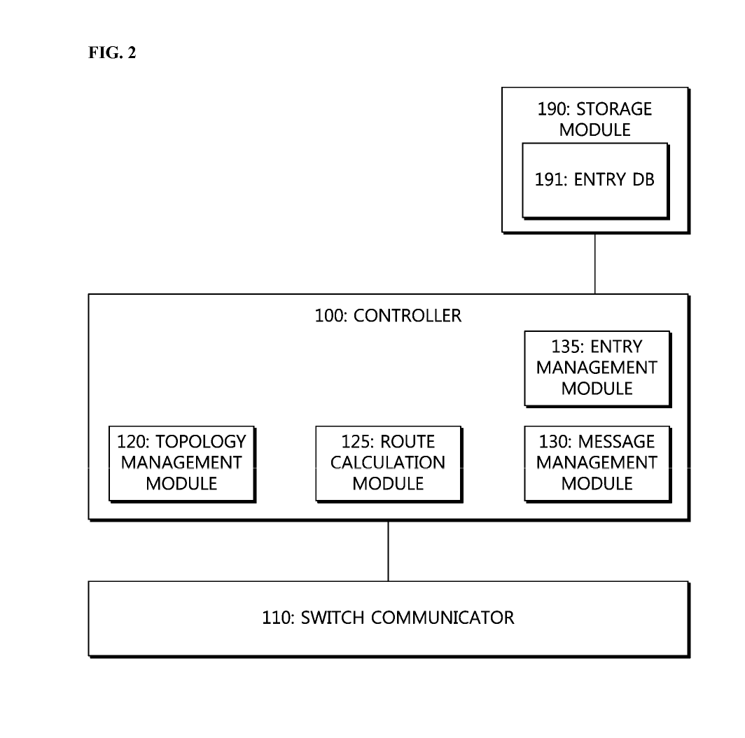

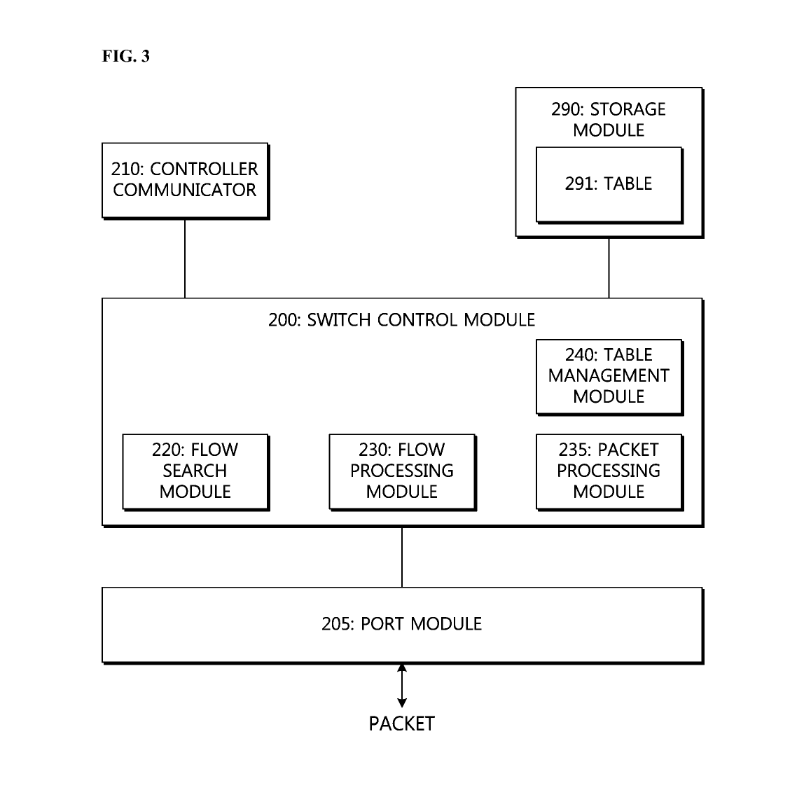

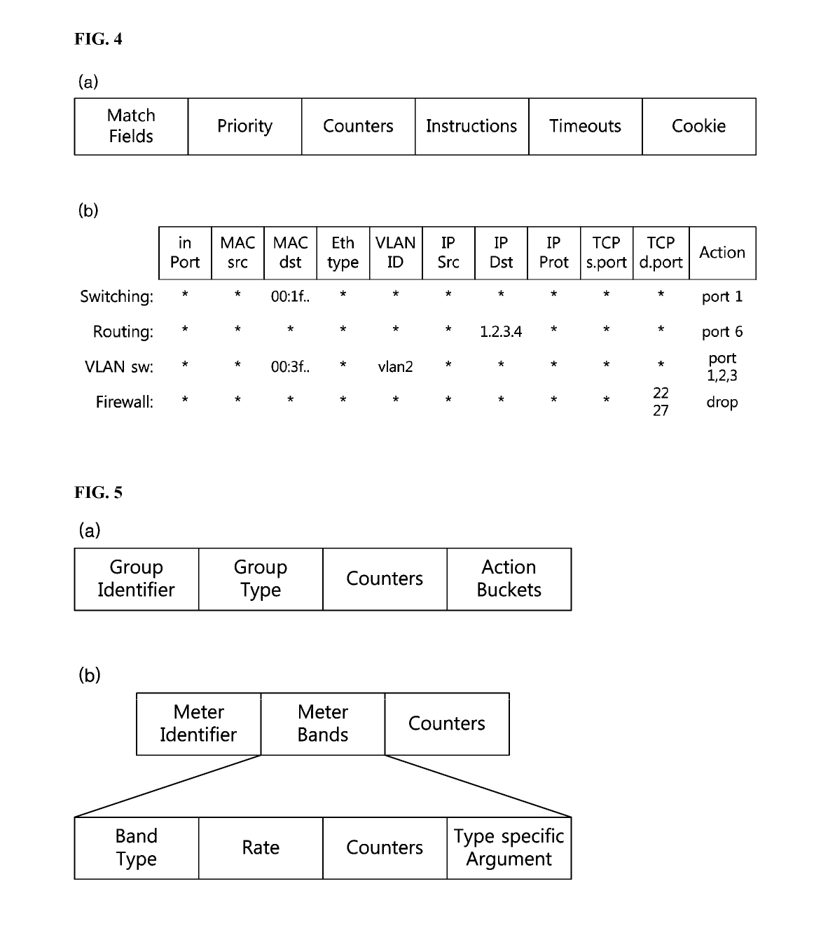

FIG. 1 is a block diagram illustrating a software-defined network (SDN) system according to an exemplary embodiment of the present invention; FIG. 2 is a block diagram illustrating a controller of the SDN system of FIG. 1; FIG. 3 is a block diagram illustrating a switch of the SDN system of FIG. 1; FIG. 4 illustrates a field table of a flow entry and an operation table showing types of operations according to the flow entry; and FIG. 5 illustrates field tables of a group table and a meter table.

Referring to FIG. 1, the SDN system may include a controller 10, a plurality of switches 20, and a plurality of network devices 30.

The network devices 30 may include user terminal devices that transmit and receive data or information, and/or physical or virtual devices that execute specific functions. In view of hardware implementation, the network devices 30 may be personal computers (PCs), client terminals, servers, workstations, super computers, mobile communication terminals, smartphones, or smart pads. In addition, the network devices 30 may be virtual machines (VMs) implemented on physical devices.

The network devices 30 may be referred to as network functions for various features on a network. The network functions may include anti-DDoS, an intrusion detection system (IDS)/intrusion prevention system (IPS), an integrated security service, a virtual private network service, an anti-virus function, an anti-spam function, a security service, an access management service, a firewall, a load balancing function, a QoS function, video optimization, and so on. Such network functions may be virtualized.

As one of the virtualized network functions, network function virtualization (NFV) is defined by NFV; Architectural framework published by the European Telecommunications Standards Institute (ETSI) (refer to non-patent document 3). In the present disclosure, the network function (NF) and NFV may be used interchangeably. The NFV may be used to dynamically generate L4-7 service connections for each tenant to provide required network functions, or in the case of DDoS attack, the NFV may be used to quickly provide policy-based required firewall, IPS and/or deep packet inspection (DPI) functions as service chaining In addition, the NFV is able to easily turn on or off firewall or IDS/IPS, and automatically perform provisioning. The NFV may reduce the need of over-provisioning.

The controller 10 is a type of command computer that controls the SDN system, and may perform various, complex functions, for example, routing, policy statement, and security check. The controller 10 may define a flow of packets in the plurality of switches 20. For the flow allowed by the network policy, the controller 10 may calculate a route (data path) for the flow to take with reference to the network topology, and allow an entry for said flow to be set on the route. The controller 10 may communicate with the switches 20 using a particular protocol, for example, OpenFlow protocol. Communication channels between the controller 10 and each switch 20 may be encrypted with secure sockets layer (SSL).

Referring to FIG. 2, the controller 10 may include a switch communicator 110 to communicate with the switches 20, a control module 100, and a storage module 190.

The storage module 190 may store programs for processing and controlling the control module 100. The storage module 190 may perform a function for temporary storage of input data or data to be output (e.g., packets, messages, and the like). The storage module 190 may include an entry database (DB) 191 to store flow entries.

The control module 100 may generally control overall operation of the controller 10 by controlling each module. The control module 100 may include a topology management module 120, a route calculation module 125, an entry management module 135, and a message management module 130. Each module may be implemented as hardware module in the control module 100, or may be implemented as software separate from the control module 100.

The topology management module 120 may establish and manage network topology information based on access relationship of switches collected by the switch communicator 110. The network topology information may include a topology between switches and a topology of network devices connected to each switch.

The route calculation module 125 may obtain both a data path of packets that have been received through the switch communicator 110 and an action column to be executed on a switch on the data path, based on the network topology information established by the topology management module 120.

The entry management module 135 may register entries in the entry DB 191, wherein the entries are based on the computation result of the route calculation module 125, policies about QoS, and user instructions. Each entry may be one of the following: a flow table, a group table, and meter table. The entry management module 135 may be proactive to allow an entry of each table to be registered in the switches 20 in advance, or be reactive to respond to a request from each switch 20 for entry addition or update. The entry management module 135 may modify or delete an entry from the entry DB 191 when necessary or in response to an entry deletion message from the switch 20.

The message management module 130 may interpret the message received through the switch communicator 110 or generate a controller-switch message to be transmitted to the switch through the switch communicator 110, which will be described later. A state change message, as one of controller-switch messages, may be created based on an entry created by the entry management module 135 or an entry stored in the entry DB 191.

The switches 20 may be physical or virtual switches that support OpenFlow. The switches 20 may relay a flow between network devices 30 by processing received packets. To this end, each switch 20 may be provided with either one flow table or multiple flow tables for pipeline processing which is specified in non-patent document 1.

The flow table may include flow entries that define rules for processing a flow of network devices 30.

The flow may indicate a packet flow of series of packets to one switch that share at least one common header field value or a packet flow along a particular route created by the combination of various flow entries of multiple switches. An OpenFlow network enables route control, recovery from failure, load balancing, and optimization to be performed on a flow-by-flow basis.

The switches 20 may be classified into edge switches (i.e., ingress switches and egress switches) at the entry and exit of the flow and core switches between the edge switches.

Referring to FIG. 3, each switch 20 may include a port module 205 to communicate with other switches and/or network devices, a controller communicator 210 to communicate with the controller 10, a switch control module 200, and a storage module 290.

The port module 205 may include a plurality of pairs of ports that connected to the switch or the network device. A pair of ports may be implemented as a single port.

The storage module 290 may store programs for processing and controlling the switch control module 200. The storage module 290 may perform a function for temporary storage of input data or data to be output (e.g., packets, messages, and the like). The storage module 290 may include a table 291, such as a flow table, a group table, and a meter table. The table 230 or table entries may be added, modified, or deleted in response to a message from the controller 10. The table entries may be discarded by the switches 20.

The flow table may consist of multiple flow tables for pipeline processing. Referring to FIG. 4, a flow entry of the flow table may include tuples of match fields, priority, counters, instruction, timeouts, and cookie, wherein the match fields describe conditions (matching rules) for matching against packets, the counters are updated when there is a matching packet, and the instruction is a set of various actions that occur when there is a matching packet in the flow entry, the timeout that specify an amount of time before the flow is expired by the switch, and the cookie is of an opaque type chosen by the controller and may be used by the controller to filter flow statistics, flow modification and flow deletion.

The instruction may modify pipeline processing, such as directing the packet to another flow table. In addition, the instruction may contain a set of actions to add to an action set or contain a list of actions to apply immediately to packets. The action may refer to an operation that forwards the packet to a particular port or modifies the packet, such as decrementing TTL field. The action may be specified as a part of the instruction set associated with a flow entry or in an action bucket associated with a group entry. The action set may refer to a set of actions instructed by each table that are accumulated. The action set may be executed when there is no matching table. FIG. 5 shows examples of processing of various packets by a flow entry.

The pipeline refers to a series of packet processing procedures between a packet and a flow table. When a packet flows into the switch 20, the switch 20 searches the flow entries of the first flow table that match with packets in the order of higher priority. If a matching flow entry is found, an instruction associated with the specific flow entry is executed. The instruction may include apply-action that is executed immediately upon finding a matching entry, clear-action/write-action that clears all actions or add or modify action(s) in the action set, write-metadata action, and goto-table that moves the packet to a designated table along with metadata. If no matching flow entry is found, the packet may be dropped or be sent to the controller 10 by encapsulating it in a packet-in message.

The group table may include group entries. The group table may provide additional forwarding methods described by flow entries. Referring to FIG. 5(a), the group entry of the group table may consist of the following fields: group identifier; group type; counters; instructions; and action buckets, wherein the group identifier identifies the group entry from other group entries, the group type specifies the rules regarding whether to execute some or all action buckets defined by the group entry, the counters are provided for analysis, like the counters in a flow entry, and the action buckets are sets of actions associated with parameters for the group.

The meter table consists of meter entries, and defines per-flow meters. The per-flow meters may enable OpenFlow to implement various QoS operations. The meter is a kind of switch element that measures and controls the rate of packets. Referring to FIG. 5(b), the meter table may consist of the following fields: meter identifier; meter bands; and counters, wherein the meter identifier identifies the meter from other meters, the meter bands specify the rate of the band and a packet operation method, and the counters are updated when packets are operated in a meter. The meter bands may consist of the following fields: band type that defines how packets are processed; rate that is used by the meter to select the meter band; counters that are updated when packets are processed by the meter band; and type specific arguments that indicate some band types that have optional arguments.

The switch control module 200 may generally control overall operation of the switch 20 by controlling each module. The switch control module 200 may include a table management module 240 that manages the table 291, a flow search module 220, a flow processing module 230, and a packet processing module 235. Each module may be implemented as hardware module in the switch control module 200, or may be implemented as software separate from the switch control module 200.

The table management module 240 may add an entry received from the controller 10 through the controller communicator 210 to an appropriate table, or regularly remove an entry from the time table when its timeout is exceeded.

The flow search module 220 may extract flow information from packets received as user traffic. The flow information may contain identification information of an ingress port that is a packet's incoming port of an edge switch, identification information of the incoming port of the switch, packet header information (IP addresses, MAC addresses, ports, and VLAN information regarding source and destination), and metadata. The metadata may be data that has been selectively added from previous tables or added from other switches. The flow search module 220 may search the table 291 for a flow entry associated with the received packet with reference to the extracted flow information. If an associated flow entry is found, the flow search module 220 may request the flow processing module 260 to process the received packet according to the found flow entry. If failing to find the associated flow entry, the flow search module 220 may send the received packet or the minimum data of the received packet to the controller 10 through the controller communicator 210.

The flow processing module 230 may process an action that outputs the packet to a particular port or multiple ports according to procedures described in the entry found by the flow search module 220, drops the packet, or modifies a specific header field of the received packet.

The flow processing module 230 may execute an instruction for pipeline processing of the flow entry or modifying an action, or may execute an action set when it is not possible to proceed to the subsequent table in the multiple flow tables.

The packet processing module 235 may actually output the packet that has been processed by the flow processing module 230 to one port or two or more ports of the port module 205 that are specified by the flow processing module 230.

Although not illustrated in FIG. 1, the SDN network system may further include an orchestrator that generates, modifies, and deletes a virtual network device, a virtual switch, and the like. When generating a virtual network device, the orchestrator may provide the controller 10 with information regarding the network device, such as, identification information of a switch for the virtual network to access, identification information of a port connected to the switch, an

MAC address, an IP address, tenant identification information, and network identification information.

The controller 10 and each switch 20 exchange a variety of information with each other, wherein such information is referred to as OpenFlow protocol messages. The OpenFlow messages may include a controller-to-switch message, an asynchronous message, and a symmetric message. Each message may have transaction id (xid) in a header to identify an entry.

The controller-switch message may be a message that is generated by the controller 10 and is sent to the switch 20 to mainly manage or inspect the state of the switch 20. The controller-switch message may be generated by the control module 100 of the controller 10, particularly, by the message management module 130.

The controller-switch message may include features that query the capabilities of a switch, configuration that queries and sets up settings of the switch 20, such as composition parameters, a state modification message for addition/deletion/modification of flow/group/meter entries in the OpenFlow table, and a packet-out message to direct the packet received through a packet-in message from the switch to be sent to a particular port of the switch. The state modification message may include a flow table modification message, a flow entry modification message, a group entry modification message, a port modification message, and a meter modification message.

The asynchronous message is generated by the switch 20, and used to update a state change of the switch and a network event in the controller 10. The asynchronous message may be generated by the control module 200 of the switch 20, particularly by the flow search module 220.

The asynchronous message may include a packet-in message, a flow-removed message, and an error message. The packet-in message may be used to send a packet from the switch 20 to the controller 10 and to receive a control for the packet. When the OpenFlow switch 20 receives an unknown packet, the packet-in message is a message that contains the received packet or a part or the entire of a copy of the received packet to be forwarded from the OpenFlow switch 20 to the controller 10 in order to request a data path. The packet-in message is used when an action of an entry that is associated with an incoming packet is set to be sent to the controller. The flow-removed message is used to forward to the controller 10 flow entry information which is to be removed from the flow table. This message is generated as the result of the controller 10 requesting the switch 20 to delete the flow entry or the flow expiry process when a flow timeout is exceeded.

The symmetry message is generated by both the controller 10 and the switch 20, and sent to a recipient without solicitation. The symmetry message may include a Hello message that is sent upon starting up a connection between the controller and the switch, an echo message to verify the liveness of a controller-switch connection, and an error message which is used by the switch or the controller to notify the other side of the connection problems. The error message is mostly used by the switch to indicate a failure of a request initiated by the controller.

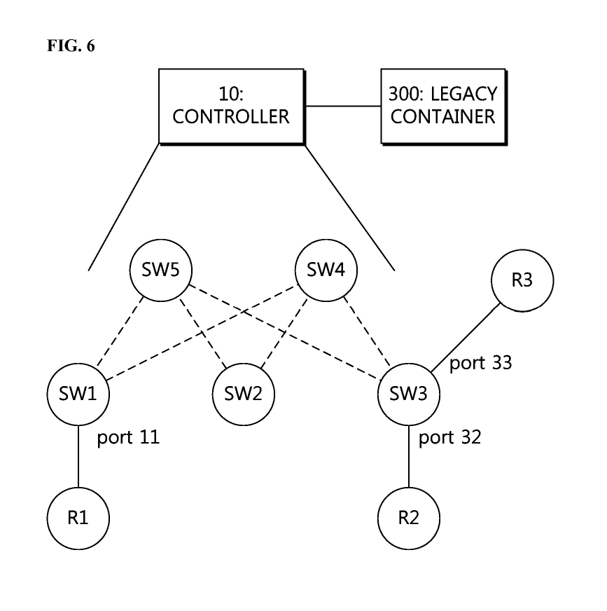

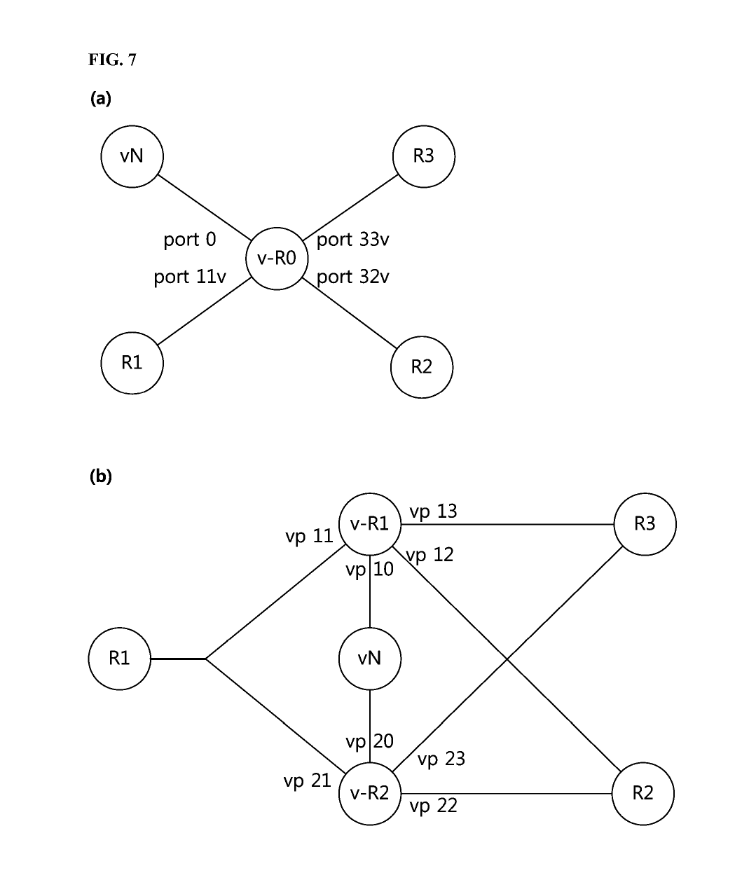

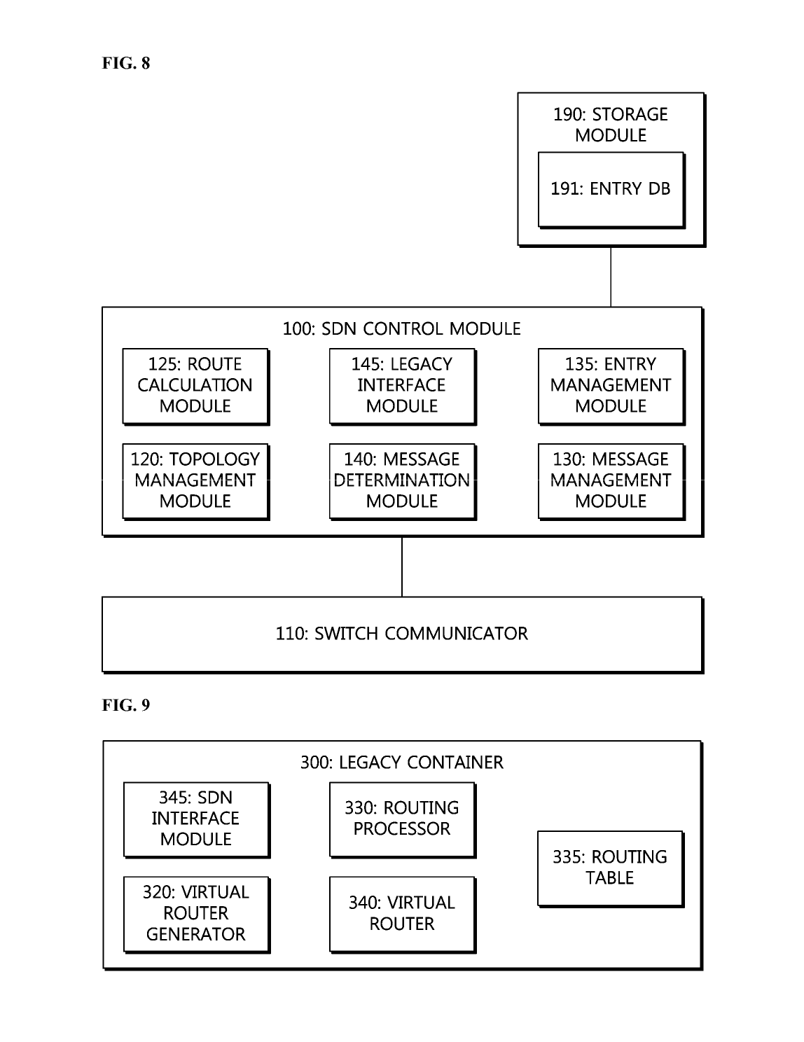

FIG. 6 is a block diagram illustrating a network system that includes an integrated routing system according to an exemplary embodiment of the present invention; FIG. 7 is a block diagram illustrating the network system of FIG. 6 being virtualized; FIG. 8 is a block diagram illustrating an SDN controller according to another exemplary embodiment of the present invention; and FIG. 9 is a block diagram illustrating a legacy routing container according to an exemplary embodiment of the present invention.

A network illustrated in FIG. 6 is mixed with an SDN-based network that includes a controller 10 that controls flows of OpenFlow switches of a switch group consisting of a plurality of switches SW1 to SW5 and a legacy network of first to third legacy routers R1 to R3. In the present disclosure, the SDN-based network refers to an independent network that consists of only OpenFlow switches or consists of OpenFlow switches and legacy switches. In the case where the SDN-based network consists of both OpenFlow switches and existing switches, preferably, but not necessarily, the network may include OpenFlow switches that are disposed at an edge of network domain.

Referring to FIG. 6, the SDN-based integrated routing system may include the switch group consisting of the first to fifth switches SW1 to SW5, the controller 10, and a legacy routing container 300. Detailed descriptions of the identical or similar elements may refer to FIGS. 1 to 5.

Among the first to fifth switches SW1 to SW5, the first and third switches SW1 and SW3 which are edge switches connected to an external network are OpenFlow switches that support OpenFlow protocol. The OpenFlow switches may be in the form of physical hardware, virtualized software, or a mixture of hardware and software.

In the present exemplary embodiment, the first switch SW1 is an edge switch connected to the first legacy router R1 through port 11, and the third switch SW3 is an edge switch connected to the second and third legacy routers R2 and R3 through port 32 and port 33, respectively. The switch group may further include a plurality of network devices (not shown) connected to the first to fifth switches.

Referring to FIG. 8, a controller 10 may include a switch communicator 110, a control module 100, and a storage module 190.

The control module 100 of the controller 10 may include a topology management module 120, a route calculation module 125, an entry management module 135, a message management module 130, a message determination module 140, and a legacy interface module 145. Each module may be implemented as hardware module in the control module 100, or may be implemented as software separate from the control module 100. Modules with the same reference numerals will refer to FIG. 2.

In the case where a switch group consists of only OpenFlow switches, the topology management module 120 and the route calculation module 125 may function as the same as described above with reference to FIGS. 1 to 5. If the switch group consists of an OpenFlow switch and an existing legacy switch, the topology management module 120 may obtain information about access to the legacy switch via the OpenFlow switch.

The legacy interface module 145 may communicate with a legacy routing container 300. The legacy interface module 145 may send topology information of the switch group that is established by the topology management module 120 to the legacy routing container 300. The topology information may contain access relationship information of the first to fifth switches SW1 to SW5 and connection or access information of a plurality of network devices that are connected with the first to fifth switches SW1 to SW5.

When it is not possible to generate processing rules for a flow provided in a flow query message that is received from the OpenFlow switch, the message management module 130 may transmit the flow to the legacy routing container 300 through the legacy interface module 145. The flow may include the packet received by the OpenFlow switch and port information of the switch that receives the packet. The case where it is not possible to generate the rules for processing the flow may include the case in which it is not possible to interpret the received packet because the packet is configured under legacy protocol and the case in which the route calculation module 125 cannot compute a route for the legacy packet.

Referring to FIG. 9, the legacy routing container 300 may include an SDN interface module 345, a virtual router generator 320, a virtual router 340, a routing processor 330, and a routing table 335.

The SDN interface module 345 may communicate with the controller 10. The legacy interface module 145 and the SDN interface module 345 may respectively act as interfaces for the controller 10 and the legacy routing container 300. The legacy interface module 145 and the SDN interface module 345 may communicate in a particular protocol or particular language. The legacy interface module 145 and the SDN interface module 345 may translate or interpret the messages exchanged between the controller 10 and the legacy routing container 300.

The virtual router generator 320 may generate and manage the virtual router 340 using topology information of a switch group that is received through the legacy interface module 145 and the SDN interface module 345. Through the virtual router 340, the switch group may be treated as a legacy router by an external legacy network, that is, the first to third routers R1 to R3.

The virtual router generator 320 may generate a plurality of virtual routers 340. The case where the virtual router 340 is a single virtual legacy router v-R0 is illustrated in FIG. 7(a); and the case where there are multiple virtual routers 340, which are virtual legacy routers v-R1 and v-R2 in FIG. 7(b).

The virtual router generator 320 may enable the virtual router 340 to be provided with a router identifier, e.g., a lookback IP address. The virtual router generator 320 may enable the virtual router 340 to be provided with virtual router ports that correspond to edge ports of the edge switches, i.e., the first and third edge switches SW1 and SW3, of the switch group. For example, as shown in FIG. 7(a), ports of the virtual legacy router v-R0 may use information of port 11 of the first switch SW1 and port 32 and port 33 of the third edge switch SW3 intact.

The ports of the virtual router 340 may be associated with identification information of a packet. The identification information of the packet may be vLAN information or tag information, such as a tunnel ID that is assigned to the packet when an access is made via a mobile communication network. In this case, it may be possible to generate a plurality of virtual router ports using a single practical port of the OpenFlow edge switch. The virtual router port associated with the identification information of the packet may contribute to the virtual router 340 operating as the plurality of virtual legacy routers. In the case where the virtual router is generated only using a physical port (actual port) of the edge switch, the number of physical ports is limited. However, if the port is associated with the packet identification information, such limitation is not applied. In addition, it is possible to allow the virtual router to operate similarly as in an existing legacy network of the packet. Further, it is possible to operate virtual legacy routers differently for each user or each user group. The user or user group may be identified by vLAN or packet identification information, such as a tunnel ID. Referring to FIG. 7(b), the switch group may be virtualized by the plurality of virtual legacy routers v-R1 and v-R2; and each port vp 11 to 13 and vp 21 to 23 of the plurality of legacy routers v-R1 and v-R2 may be associated with packet identification information.

Referring to FIG. 7(b), access between the plurality of virtual legacy routers v-R1 and v-R2 and the first legacy router R1 may be made through a number of sub-interfaces that are generated by dividing one actual interface or through a plurality of actual interfaces, e.g., the second and third legacy routers R2 and R3.

The virtual router generator 320 may allow the first to third routers R1 to R3 to treat a plurality of network devices that are connected to the first to fifth switches SW1 to SW5 as an external network vN that is connected to the virtual router 340. By doing so, the legacy network may be able to access to the network devices of the OpenFlow switch group. In the case of FIG. 7(a), the virtual router generator 320 generates port 0 for zero virtual legacy routers v-R0. In the case of FIG. 7(b), the virtual router generator 320 generates port 10 vp 10 and port 20 vp 20 for the first and second virtual legacy routers v-R1 and v-R2. Each of the generated ports, i.e., port 0, port 10 vp 10, and port 20 vp 20, may be provided with the same information as generated when the ports are connected to the plurality of network devices of the switch group. The external network vN may consist of all or some of the plurality of network devices.

Information of the virtual router ports, i.e., port 0, port 11v, port 32v, port 33v, vp 10 to13, and vp 20 to 23 may contain port information that is possessed by the legacy router. For example, the virtual router port information may include information regarding each virtual router port, such as, an MAC address, an IP address, an address range of a network connected, legacy router information thereof, and may further include a vLAN range, a tunnel ID range, and so on. The port information may be inherited edge port information of the first and third edge switches SW1 and SW3 or designated by the virtual router generator 320.

Data plane of the network of FIG. 6 that is generated by the virtual router 340 may be virtualized as shown in FIG. 7(a) or FIG. 7(b). For example, in the case of FIG. 7(a), in the virtualized network, the first to fifth switches SW1 to SW5 may be virtualized to the virtual legacy router v-R0, port 11 11v, port 32 32v and port 33 33v of the zero virtual legacy router v-R0 may be connected to the first to third legacy routers R1 to R3, respectively, and port 0 of the zero virtual legacy router v-R0 may be connected to the external network vN, which is at least a part of the plurality of network devices.

The routing processor 330 may generate the routing table 335 in response to the generation of the virtual router 340. The routing table 335 is a table used to be referenced by the legacy router for routing. The routing table 335 may consist of all or some of RIB, FIB, and ARP tables. The routing table 335 may be modified or updated by the routing processor 330.

The routing processor 330 may generate a legacy routing route for a flow that is queried by the controller 10. The routing processor 330 may generate legacy routing information using all or some of the following: the packet received by the OpenFlow switch that is provided to the flow, information about an incoming port of the received packet, information about the virtual router 340, the routing table 335, and so on. The legacy routing information may have the legacy routing route.

The routing processor 330 may include a third-party routing protocol stack to determine legacy routing.

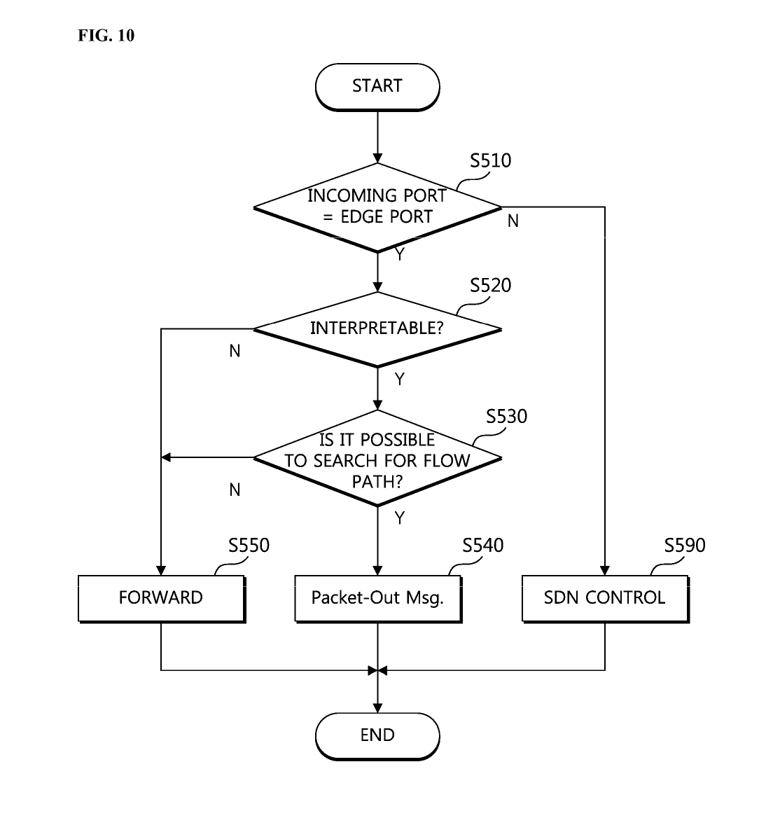

FIG. 10 is a flowchart of a method of the controller of FIG. 6 to determine whether to perform legacy routing for a flow. Hereinafter, the method will be described with reference to FIG. 10 in conjunction with FIGS. 6 to 9.

The method for determining whether to perform legacy routing for a flow relates to whether the controller 10 performs a generic SDN control for a flow received from the OpenFlow switch or queries the legacy routing container 300 for flow control.

Referring to FIG. 10, the controller 10 determines whether a flow incoming port is an edge port or not in S510. If the flow incoming port is not an edge port, the controller 10 may perform SDN-based flow control, such as, calculating a route for generic OpenFlow packets in S590.

If the flow incoming port is an edge port, the controller 10 determines whether a packet of the flow is interpretable or not in S520. If the packet is not interpretable, the controller 10 may forward the flow to the legacy routing container 300 in S550. This is because if the packet is a protocol message that is used only in a legacy network, a general SDN-based controller cannot interpret such packet.

If the received packet is a legacy packet which is the same as the packet to be transmitted from the first legacy network to the second legacy network, the SDN-based controller 10 is not able to calculate a routing route for the incoming legacy packet. Thus, when the controller 10 cannot calculate the packet, such as a legacy packet, it may be desirable that the controller 10 forwards the legacy packet to the legacy routing container 300. However, if the edge port through which the packet flows out and a final processing method for the legacy packet are known, the controller 10 may be able to process the legacy packet by flow modification. If the packet is interpretable, the controller 10 may determine its availability, whether the controller 10 can calculate a path of the flow, or searches for a flow path, such as searching an entry table for a flow entry in S530. If it is not possible to search for the flow path, the controller 10 may forward the flow to the legacy routing container 300 in S550. If it is possible to search for the flow path, the controller 10 may generate a packet-out message that specifies an output of the packet and sends the message to the OpenFlow switch that has queried the packet in S540.

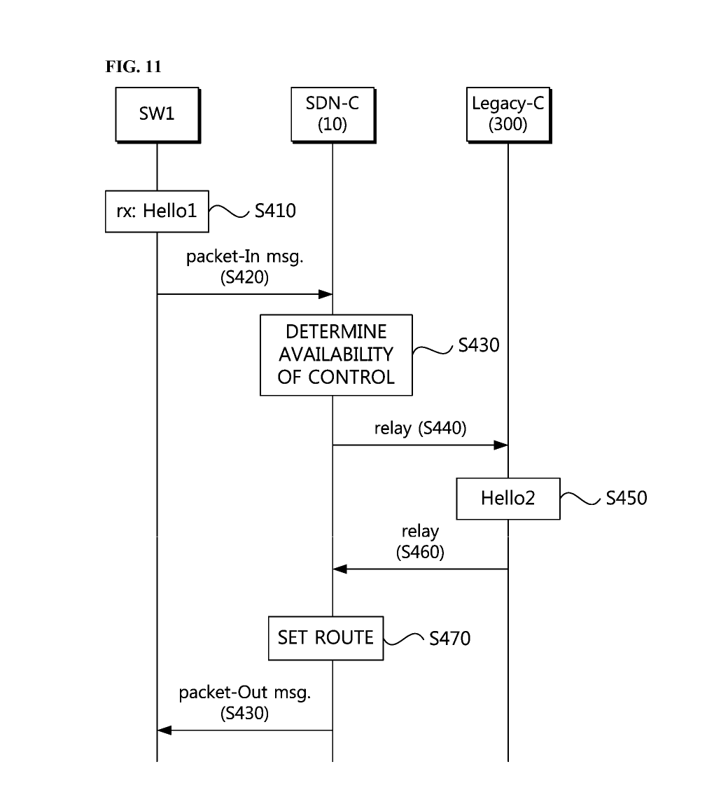

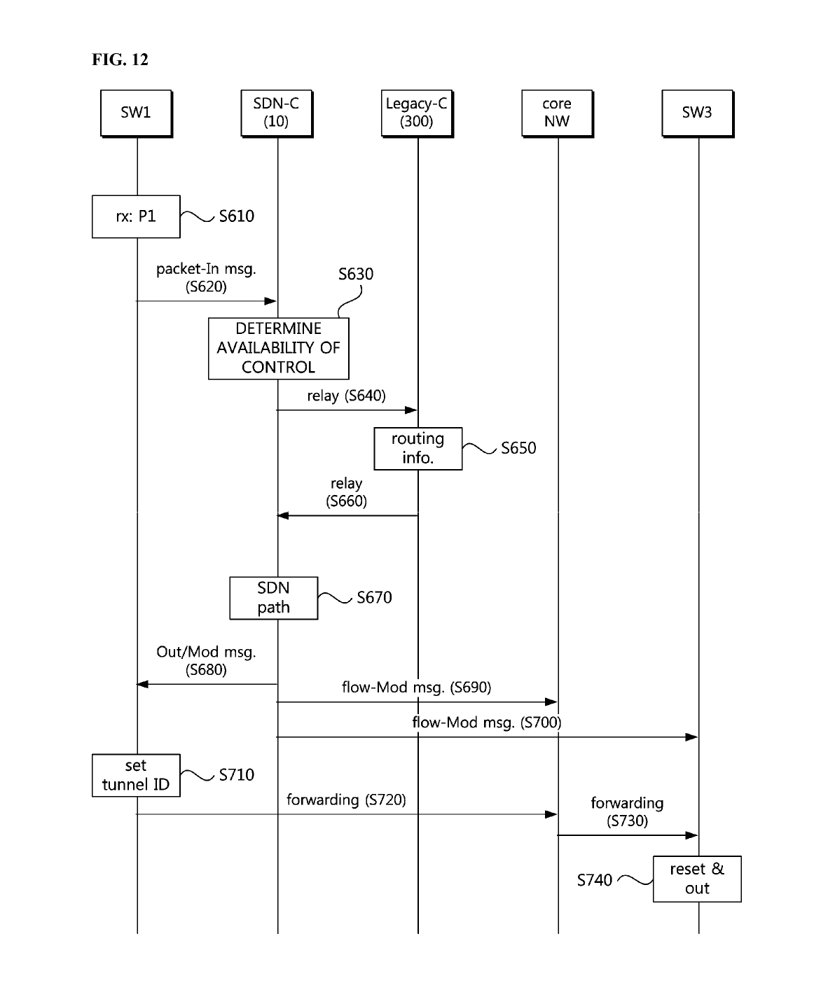

Each case will be described in detail with reference to FIGS. 11 and 12.

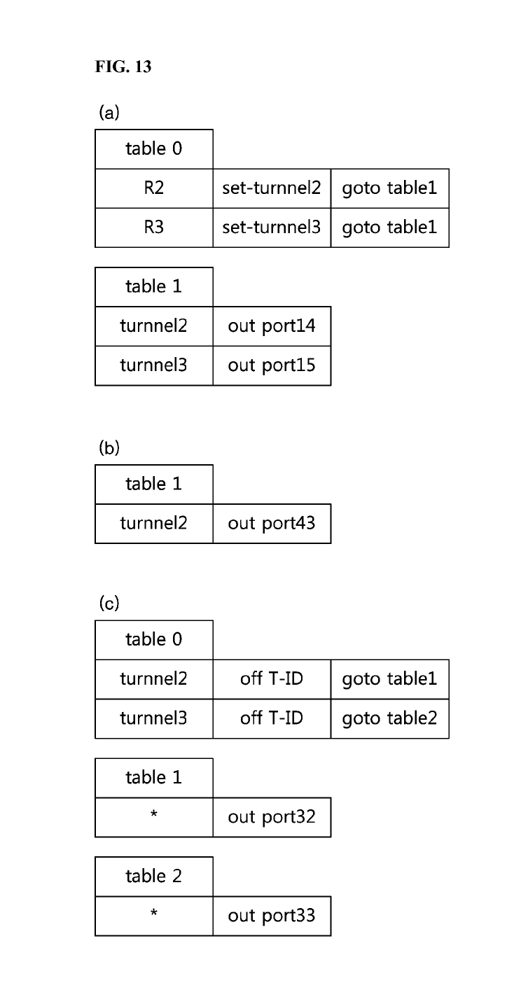

FIG. 11 is a signal flow chart according to an integrated routing method according to an exemplary embodiment of the present invention; FIG. 12 is a signal flow chart illustrating an integrated routing method according to another exemplary embodiment of the present invention; and FIG. 13 is a flow table according to an exemplary embodiment of the present invention. The following descriptions will refer to FIGS. 6 to 10.

FIG. 11 illustrates a flow of processing a legacy protocol message in an SDN-based network to which the present invention applies. FIG. 11 illustrates an example case in which the first edge switch SW1 receives a hello message of open shortest path first (OSPF) protocol.

The example of FIG. 11 assumes that the OpenFlow group is virtualized as shown in FIG. 7(a) by the controller 10 and the legacy routing container 300.

Referring to FIG. 11, when a first legacy router R1 is connected to a first edge switch SW1, the first legacy router R1 may send a hello message, which is referred to as Hello1 in the drawing, of OSPF protocol to the first edge switch SW1 in S410.

Since the table 291 of the first edge switch SW1 does not have a flow entry for a received packet, the first edge switch SW1 sends a packet-in message to indicate an unknown packet to the controller 10 in S420. The packet-in message may preferably, but not necessarily, include a flow that has information about Hello1 packet and incoming port (port 11).

The message management module 130 of the controller 10 may determine whether or not it can generate rules for processing the flow in S430. The details of the determination method are provided with reference to FIG. 10. In the present example, as an OSPF protocol message is a packet that the controller 10 is not able to interpret, the controller 10 may forward the flow to the legacy routing container 300 in S440.

The SDN interface module 345 of the legacy routing container 300 may send the hello1 packet to the port 11 v of the virtual router 340 that corresponds to the incoming port, i.e., port 11, of the first edge switch SW1 provided to the flow. In response to the virtual router 340 receiving the Hello1 packet, the routing processor 330 may generate legacy routing information of the Hello1 packet based on the routing table 335 in S450. In the exemplary embodiment, the routing processor 330 may generate a Hello2 message that corresponds to the Hello1 message, and create a routing route that designates an output port to port 11v such that a Hello2 packet can be sent to the first legacy router R1. The Hello2 message may have a destination that is the first legacy router R1 and a previously specified virtual router identifier. The legacy routing information may include Hello2 packet and an output port, i.e., port 11v. Although the Hello1 packet flows into the virtual router 340 in the exemplary embodiment, the aspects of the present invention are not limited thereto, such that the routing processor 330 may generate legacy routing information using information regarding the virtual router 340.

The SDN interface module 345 may forward the generated legacy routing information to the legacy interface module 145 of the controller 10 in S460. Either the SDN interface module 345 or the legacy interface module 145 may convert port 11v that is an output port to port 11. Alternatively, such port conversion may be omitted by assigning the same name to both port 11v and port 11.

The route calculation module 125 of the controller 10 may set up a route using the legacy routing information received through the legacy interface module 145 in order to allow the Hello2 packet to be output through port 11 of the first legacy router R1 in S470.

The message management module 130 may create a packet-out message using the set route and the legacy routing information to direct the Hello2 packet to be output through port 11 that is an incoming port, and sends the created message to the first legacy router R1 in S480.

Although the present exemplary embodiment describes that the Hello messages correspond to hello messages of an external legacy router, the aspects of the present invention are not limited thereto. For example, the legacy routing container 300 may create an OSPF Hello message to direct the Hello packet to be actively output to an edge port of the edge switch, and send the created message to the controller 10. In this case, the controller 10 may transmit the Hello packet to the OpenFlow switch by sending a packet-out message. In addition, even a packet-out message that does not correspond to a packet-in message may be implemented as the present exemplary embodiment by setting the OpenFlow switch to operate as directed by the packet-out message.

FIG. 12 illustrates the case where a generic legacy packet is sent from the first edge switch SW1 to the third edge switch SW3.

The flow of FIG. 12 starts with S610 in which the first edge switch SW1 receives from the first legacy router R1 a legacy packet P1 with a destination IP address that does not belong to an OpenFlow switch group.

Because the first edge switch SW1 does not have a flow entry for the packet P1, the first edge switch SW1 may send the packet P1 to the controller 10 and query the flow processing (by sending a packet-in message) in S620.

The message management module 130 of the controller 10 may determine whether SDN control is available for the flow in S630. In the present example, as the packet P1 is interpretable, but directed toward the legacy network, the controller 10 is not able to generate a route for the packet P1. Thus, the controller 10 may relay both the packet P1 and port 11, which is an incoming port, to the legacy routing container 300 through the legacy interface module 145 in S640.

The routing processor 330 of the legacy routing container 300 may generate legacy routing information for the packet P1 that is forwarded from the controller 10 based on the information of the virtual router 340 and the routing table 335 in S650. The present example assumes that the packet P1 must be output to port 32v of the virtual router 340. In this case, the legacy routing information may contain an output port of the packet P1 that is port 32v, a destination MAC address that is a MAC address of the second legacy router R2, and a source MAC address that is a MAC address of port 32v. This information is header information of a packet to be output from the legacy router. For example, in the case where a report packet P1 is sent from the first legacy router R1 to the virtual legacy router v-R0, the packet P1 has the following header information. As the source and destination IP addresses are the same as those in the header information at the time of creation of the packet P1, the descriptions thereof will be omitted. The source MAC address of the packet P1 is a MAC address of an output port of the router R1. The destination MAC address of the packet P1 is a MAC address of port 11v of the virtual legacy router v-R0. In the case of an existing router, a packet P1′ to be output to port 32v of the virtual legacy router v-R0 may have the following header information. A source MAC address of the packet P1′ is a MAC address of port 32v of the virtual legacy router v-R0, and a destination MAC address thereof is a MAC address of an incoming port of the second legacy router. That is, some header information of the packet P1 is altered in the legacy routing process.

To correspond to legacy routing, the routing processor 330 may generate a packet P1′ by modifying header information of the packet P1 and include the packet P1′ in the legacy routing information.

However, it is more preferably that the routing processor 330 does not generate the packet P1′. Since, in case of modifying header information of the packet P1 in the routing processor 330, the controller 10 or the legacy routing container 300 may need to process all incoming packets that are the identical packets or similar packets having the same destination address range. Thus, in the operation of converting a format of the packet to an existing format after routing, preferably, an edge switch (the third edge switch SW3 in the present example) that outputs the packet to the external legacy network may manipulate the packet, rather than the legacy routing container 300. To this end, the legacy routing information described above may contain source and destination MAC addresses. The controller 10 may use the routing information to send a flow modification (flow-Mod) message to the third edge switch to modify the header information of the packet P1 suitable for a legacy routing protocol.

The SDN interface module 345 may relay the generated legacy routing information to the legacy interface module 145 of the controller 10 in S660. In S660, a port may be changed to an edge port that is mapped with an output port.

The controller 10 may generate flow processing rules of an OpenFlow switch group based on the legacy routing information, specially a legacy routing route in the legacy routing information, received through the legacy interface module 145. Thus, in S670, the route calculation module 125 of the controller 10 may calculate a route that enables the packet from the first edge switch SW1 to be output to port 32 of the third edge switch SW3 by using the legacy routing route.

The message management module 130 may send a packet-out message to the first edge switch SW1 to designate an output port for the packet P1 in S680, and send a flow modification (flow-Mod) message to the OpenFlow switches on the route in S690 and S700. The message management module 130 may send the flow-Mod message to the first edge switch SW1 to specify the processing of the same flow.

A flow entry according to the flow processing rules may be preferably based on an identifier added in a data-packet corresponding to a flow that manages a path of the packet P1.

Therefore, the flow processing for the packet P1 may be performed based on the identifier that identifies the legacy flow. To this end, the packet-out message to be sent to the first edge switch SW1 may include the packet P1 with a legacy identifier (tunnel ID) assigned thereto, and the flow modification message may include a flow entry that indicates the assignment of the legacy identifier (tunnel ID). Examples of flow tables of each switch refer to FIG. 13. FIG. 13(a) is a flow table of the first edge switch SW1. For example, table 0 of FIG. 13(a) directs tunnel2 to be assigned to a flow that is directed to the second legacy router R2 as a legacy identifier and directs the flow to move to table 1. The legacy identifier may be written in a meta-field or another field. Table 1 includes a flow entry that indicates a flow with tunnel2 to be output to port 14 (port information of the first switch SW1 connected to the fourth switch SW4). FIG. 13(b) illustrates an example of a flow table of the fourth switch SW4. The table of FIG. 13(b) directs the flow having tunnel2 as a legacy identifier to be output to port 43 that is connected to the third switch SW3. FIG. 13(c) illustrates an example of a flow table of the third switch SW3. Table 0 of FIG. 13(c) directs the flow having tunnel2 as a legacy identifier to remove the legacy identifier therefrom, and directs the flow to move to table 1. Table 1 directs the flow to be output to port 32. With the multiple tables as described above, it is possible to reduce the number of cases. This allows for quick search and reduction in the consumption of resources such as memory.

The first edge switch SW1 may assign the legacy identifier (tunnel ID) to the packet P1 in S710 or send the packet having the legacy identifier (tunnel (ID) assigned thereto to a core network in S720. The core network may be a network consisting of OpenFlow switches SW2, SW4, and SW5, other than the edge switches SW1 and SW3.

The core network may send the flow to the third edge switch SW3 in S730. The third edge switch SW3 may output the packet P1, which has the legacy identifier removed therefrom, to the designated port in S740. In this case, although not illustrated in the flow table of FIG. 13, the flow table of the third switch SW3 may preferably, but not necessarily, include a flow entry that indicates the modification of source and destination MAC addresses of the packet P1.

According to the exemplary embodiments of the present invention, it is possible to easily extend the scalability for processing legacy routing of control plane while using existing legacy network equipment and SDN network equipment which are actually applied and allowing both protocols to co-exist. In addition, it is possible to forward information of SDN domain to a legacy domain.

The current embodiments can be implemented as computer readable codes in a computer readable record medium. Codes and code segments constituting the computer program can be easily inferred by a skilled computer programmer in the art. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

The exemplary embodiments of the present invention may include a carrier wave that has electronically readable control signals stored thereon and may be operated as a programmable computer system in which one of the methods described herein is executed. The exemplary embodiments may be implemented as a computer program product having a program code, and the program code is operated to perform any of the methods described herein when the computer program runs on a computer. The program code may also be stored on a machine-readable carrier, for example. An embodiment of the present invention thus is a computer program which has a program code for performing any of the methods described herein, when the computer program runs on a computer. The present invention may include a computer or a programmable logic device for performing one of the methods described herein. In some embodiments, a programmable logic device (for example a field-programmable gate array, a CMOS-based logic circuit) may be used for performing some or all of the functionalities of the methods described herein.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An integrated routing method in an integrated routing system based on a software-defined network (SDN), comprising:
obtaining information regarding a plurality of edge switches that are SDN-based switches and belong to a switch group that establishes an independent network; and
setting the independent network as at least one virtual router, based on the obtained information regarding the plurality of edge switches, such that the independent network is treated as at least one legacy router by a plurality of legacy networks that are connected to the independent network.

2. The integrated routing method of claim 1, wherein the at least one virtual router comprises a virtual router port and information of the virtual router port corresponds to information of an edge port of one of the plurality of edge switches that is connected to at least some of the plurality of legacy networks.

3. The integrated routing method of claim 2, wherein the virtual router port is associated with identification information of a packet.

4. The integrated routing method of claim 1, further comprising:
setting at least some of a plurality of network devices that are connected to the switch group to be treated as an external network that is connected to the at least one virtual network by the plurality of legacy networks.

5. The integrated routing method of claim 1, wherein the at least one virtual router has a router identifier.

6. The integrated routing method of claim 1, further comprising:
receiving, at a controller, a query packet and edge port information from a first edge switch among the plurality of edge switches;
in a case where the controller is not capable of SDN control of the query packet, transmitting the query packet and the edge port information to a legacy routing container that is connected to the controller; and
generating, at the legacy routing container, legacy routing information based on the query packet, the edge port information, and information regarding the at least one legacy router.

7. The integrated routing method of claim 6, wherein the generating of the legacy routing information comprises, in a case where the query packet is a legacy protocol message, interpreting the legacy protocol message.

8. The integrated routing method of claim 7, wherein the legacy routing information contains a legacy protocol reply message that responds to the legacy protocol message.

9. The integrated routing method of claim 6, further comprising:
at the controller, generating flow processing rules of an OpenFlow switch group for a legacy routing route in the legacy routing information, wherein the OpenFlow switch group is at least part of the switch group establishing the independent network.

10. The integrated routing method of claim 9, wherein a flow entry according to the flow processing rules is based on an identifier added in a data-packet corresponding to a flow that manages a path of the query packet.

11. The integrated routing method of claim 10, wherein the plurality of edge switches comprise a second edge switch that is connected to a second legacy network, and the second edge switch is an end of the path of the query packet, the second edge switch has a flow entry that removes the identifier from the data-packet.

12. The integrated routing method of claim 11, wherein either or both of addition and deletion of the identifier is processed by at least one flow entry in one or more flow tables for pipeline processing.

13. The integrated routing method of claim 6, wherein the plurality of edge switches comprise a third edge switch outputting the query packet to a third legacy network,
at the controller, sending a flow modification message to the third edge switch to modify the header information of the query packet suitable for a legacy routing protocol.

14. The integrated routing method of claim 7, wherein a case where the controller is not capable of SDN control of the flow includes a case in which an incoming port of the flow is an edge port, a case in which a packet of the flow is not interpretable and a case in which no search result of the flow is found.

15. An integrated routing system based on an SDN, comprising:
a switch group establishing an independent network and including a plurality of OpenFlow edge switches that are connected to a plurality of legacy networks;
a controller configured to obtain information regarding the plurality of OpenFlow edge switches; and
a legacy routing container configured to generate at least one virtual router based on the obtained information regarding the plurality of OpenFlow edge switches, such that the plurality of legacy networks to treat at least part of the switch group as a legacy router, and to generate legacy routing information in response to a flow processing query message from the controller based on information about the at least one virtual router.

16. The integrated routing system of claim 15, wherein the legacy routing container maps at least part of a plurality of network devices connected to the plurality of OpenFlow switches to information of an external network that is directly connected to the at least one virtual router.

17. The integrated routing system of claim 15, wherein the virtual router information comprises router identifier, first legacy router port information that contains information about a port which corresponds to a first edge port of a first edge switch connected to a first legacy network, and second legacy router port information that contains information about a port which corresponds to a second edge port of a second edge switch connected to a second legacy network.

18. A legacy routing container comprising:
an SDN interface module configured to communicate with a controller that obtains information regarding a plurality of OpenFlow edge switches that are connected to a plurality of legacy networks and belong to a switch group;
a virtual router generator configured to generate at least a part of the switch group, which has been received through the SDN interface module, as at least one virtual router; and
a routing processor configured to, in response to generation of the at least one virtual router, generate a routing table to be referenced for legacy routing and to generate a legacy routing route for a flow queried by the controller.
